(19) United States
(12) Patent Application Publication
(10) Pub. No.: US 2006/0030188 A1
(43) Pub. Date: Feb. 9, 2006

(54) Safety plug allowing unplugging with one hand

(75) Inventors: Jeng Je Pan, Taipei City (TW); Choliang Liang, Taipei County (TW)

Correspondence Address: PAN, JENG JE;Xinyi District, 9F., No. 37, Dongsing Road,, Taipei City, 110, TW

(73) Assignee: Ahoku Electronic Company

(21) Appl. No.: 11/044,910

(22) Filed: Jan. 28, 2005

(30) Foreign Application Priority Data
Aug. 9, 2004 (TW) 93212611

(51) Int. Cl. H01R 13/62

(52) U.S. Cl. 439/160

(57) ABSTRACT

A safety plug intended for home electrical appliances and various electronic products allows a user to easily and safely unplug it with only one hand. The safety plug includes a plug body having a contact surface provided with a power connection unit, a power cord connected to one side other than the contact surface, and a through hole provided at a predetermined place normal to and extended to the contact surface; and a push-off key having a shank portion axially movably located in the through hole of the plug body, and an expanded head portion connected to a top of the shank portion. By pushing against the head portion with a thumb to project the shank portion from the contact surface of the plug body, the whole safety plug could be effortlessly and safely unplugged from a socket.

### FIELD OF THE INVENTION

The present invention relates to a safety plug allowing unplugging with one hand, and more particularly to a safety plug for connecting to a power source and allowing a user to unplug it in an effortless and safe manner.

### BACKGROUND OF THE INVENTION

A plug is an element via which current is supplied from a power source to an electric appliance, an electric machine, mechanical equipment, or electronic components. The plug typically has a plug body made of an insulating material. On one side of the plug body there is provided a power connection unit, which is electrically connected to a power cord extended from another side of the plug body, so that the power cord obtains power supply via the power connection unit to supply electric energy required by the above-mentioned electric appliance and the like connected to the power cord. The power connection unit may be blades, usually including a positive and a negative blade and a grounding prong, projected from the contact surface, or terminal insertion holes formed on the contact surface.

To ensure that the conventional plug, either having blades or terminal insertion holes provided on the contact surface of the plug body, is firmly plugged into a wall receptacle, an extension cord, or the electric, mechanical, or electronic product for actually supplying electrical energy to the electric, mechanical, or electronic product via the power connection unit, an additional spring strip holding structure, such as elastic conductive strips provided in each slot on a socket or receptacle for clamping the positive and the negative blade and the grounding prong therebetween, is often employed. With the spring strip holding structure, a user has to unplug the plug by forcefully pulling out the plug body from the socket or receptacle, particularly a movable one, such as an extension cord, with one hand and holding the movable receptacle in place with the other hand. When the user unplugs the plug in an incorrect manner, such as directly forcefully pulling the power cord connected to the plug body, it is very possibly the plug is damaged and the user's hand pulling the power cord collides with some other things nearby the plug.

In brief, the conventional plug is not ideally designed to enable easy and safe unplugging thereof.

### SUMMARY OF THE INVENTION

A primary object of the present invention is to provide a safety plug allowing unplugging with one hand, so that a user may unplug the safety plug in an effortless and safe manner with the help of an auxiliary push-off structure, and the safety plug may be well protected to have a prolonged usable life.

To achieve the above and other objects, the safety plug of the present invention mainly includes a plug body having a contact surface provided with a power connection unit, a power cord connected to one side other than the contact surface, and a through hole provided at a predetermined place normal to and extended to the contact surface; and a push-off key having a shank portion axially movably located in the through hole of the plug body, and an expanded head portion connected to a top of the shank portion. By gripping the safety plug at a joint of the plug body and the power cord with one or more fingers of one hand and pushing against the head portion of the push-off key with the thumb of the same hand to downward project the shank portion from the contact surface of the plug body, the whole safety plug, including the plug body and the power connection unit, could be effortlessly unplugged from a socket.

In a preferred embodiment of the present invention, a transverse bar is provided in the through hole of the plug body, and an axially extended guide slot is provided on the shank portion of the push-off key, so that the transverse bar is extended across the guide slot to serve as a guide for the shank portion of the push-off key to move axially.

In another embodiment of the present invention, the shank portion of the push-off key has at least one hollow sleeve connected to a lower end thereof to locate around the power connection unit. When the push-off key is depressed, the shank portion with the hollow sleeve pushes the power connection unit off the socket while protects the user from undesirably contacting with the power connection unit.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a safety plug allowing unplugging with one hand according to a preferred embodiment of the present invention;

FIG. 2 is an assembled sectional view of the safety plug of FIG. 1;

FIG. 3 shows the manner of unplugging the safety plug of the present invention with only one hand;

FIG. 4 is a perspective view of a variation of the safety plug of FIG. 1;

FIG. 5 is a perspective view of a safety plug of the present invention structurally similar to that of FIG. 1 but with terminal insertion holes instead of blades provided on the plug;

FIG. 6 is a perspective view of a safety plug of the present invention structurally similar to that of FIG. 1 but with a plurality of small terminal insertion holes instead of blades provided on the plug;

FIG. 7 is an assembled perspective view of a safety plug allowing unplugging with one hand according to another embodiment of the present invention; and

FIG. 8 shows the manner of unplugging the safety plug of FIG. 7.

### DETAILED DESCRIPTION OF THE PREFERRED EMBODIMENTS

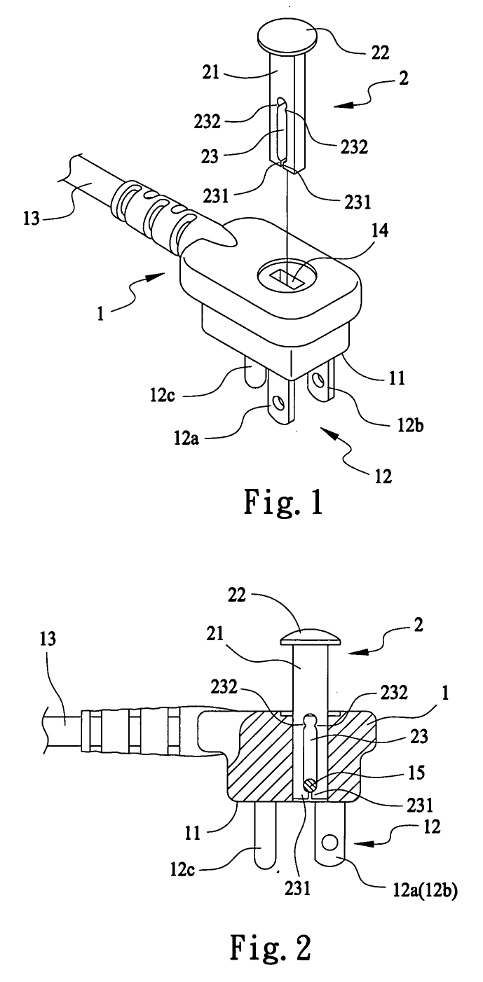

Please refer to FIG. 1 that is an exploded perspective view of a safety plug allowing unplugging with one hand according to a preferred embodiment of the present invention intended for various kinds of home electrical appliances, electrical machines, mechanical equipment, and electronic products. As shown, the safety plug of the present invention mainly includes a plug body 1 and a push-off key 2.

The plug body 1 may be an integrally molded or an assembled insulating structure serving as a seat, and may be differently shaped to be, for example, a rectangular (see FIG. 6), a round, an oblong, or any other specific geometrical or irregular shape (see FIGS. 1, 4 and 5) without being restricted to any particular configuration. The plug body 1 is provided at one side with a contact surface 11, at where at least one power connection unit 12 is provided, and at any side other than the contact surface 11, such as at a lateral side or an upper side, with a power cord 13 to electrically connect with the power connection unit 12. The plug body 1 of the present invention is characterized in that it is further provided at a selected place, such as at a top center of the plug body 1 as shown in FIG. 1, or at one lateral side of the plug body 1 as shown in FIG. 6, with at least one through hole 14 normal to the contact surface 11. The through hole 14 is internally provided at a central area with a transverse bar 15, as can be seen from FIG. 2, and has an inner end extended to the contact surface 11 of the plug body 1.

The push-off key 2 includes a shank portion 21 (see FIG. 1), and an expanded head portion 22 integrally formed on or separately assembled to a top of the shank portion 21 for a user to apply a downward force thereat. The shank portion 21 is provided at a predetermined position with an axially extended guide slot 23, which has dimensions matching that of the transverse bar 15 in the through hole 14 of the plug body 1.

The shank portion 21 of the push-off key 2 is axially movably located in the through hole 14 of the plug body 1, as shown in FIG. 2, with the expanded head portion 22 exposed and projected from the plug body 1. The shank portion 21 of the push-off key 2 before being axially pushed downward into the through hole 14 of the plug body 1 has a lower end opposite to the head portion 22 aligned with the contact surface 11 of the plug body 1 with the transverse bar 15 extended across the guide slot 23 on the shank portion 21.

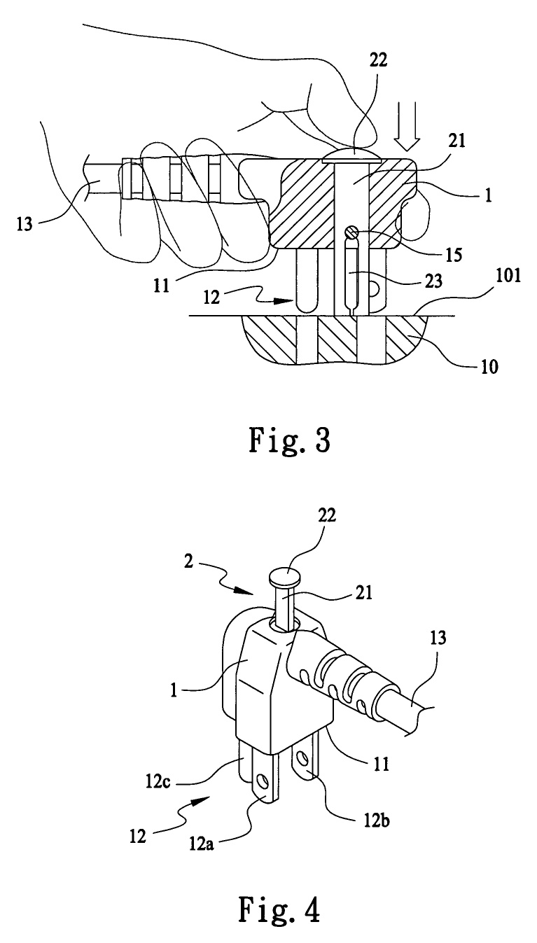

FIG. 3 shows the manner of unplugging the safety plug of the present invention with only one hand. When it is desired to unplug the safety plug of the present invention from a fixed or a movable socket 10 or other electric equipment, to which the power connection unit 12 on the plug body 1 is connected, a user needs only to grip the safety plug at a joint of the plug body 1 and the power cord 13 or other suitable point with one or more fingers of one hand, and depress the push-off key 2 with the thumb of the same hand until the lower end of the shank portion 21 is firmly pressed against an end surface 101 of the socket 10 or the electric equipment. At this point, a reacting force is generated at the lower end of the shank portion 21 to cause separation of the plug body 1 and the power connection unit 12 from the socket 10 or the electric equipment, allowing the user to effortlessly unplug the safety plug with only one hand. That is, unlike in the case of the conventional plug, the user need not troublesomely hold down the socket or receptacle with one hand while unplugging the plug with the other hand, and the danger of collision of the user's hand with nearby articles when the hand is forcefully pulled outward to unplug the plug is avoided.

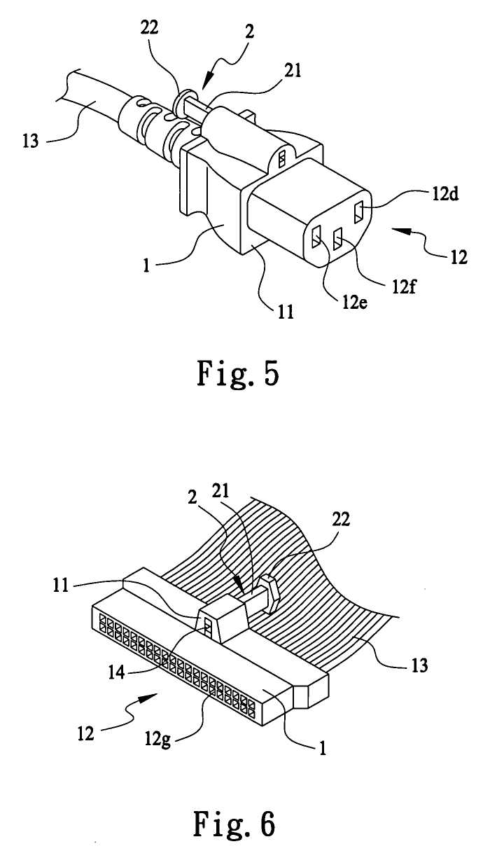

As having been mentioned above, the plug body 1 is not necessarily restricted to any particular shape. Moreover, the power connection unit 12 may also be differently designed in response to the configurations of sockets or electric equipment adopted in different countries or areas. In FIG. 1, the power connection unit 12 includes a positive and a negative blade 12a, 12b and a grounding prong 12c projected from the contact surface 11 of the plug body 1. In FIG. 5, the power connection unit 12 includes a positive slot 12d, a negative slot 12e, and a ground slot 12f formed on the contact surface 11 of the plug body 1. In FIG. 6, the power connection unit 12 includes a plurality of small terminal insertion holes 12g formed on the contact surface 11 of the plug body 1. Briefly speaking, the provision of the through hole 14 and the push-off key 2 on differently shaped plug body 1 of the safety plug of the present invention enables the safety plug to be safely and effortlessly unplugged with only one hand.

Please refer back to FIGS. 1 and 2. The shank portion 21 of the push-off key 2 is provided at a lower end of at least one sidewall of the guide slot 23 with a first inward protrusion 231, and near an upper end of at least one sidewall of the guide slot 23 with a second inward protrusion 232. In the illustrated embodiment, there are two first and two second protrusions 231, 323 separately provided on two sidewalls of the guide slot 23. The first and the second protrusion 231, 232 serve as a lower and an upper dead point, respectively, for the transverse bar 15 in the guide slot 23, lest the push-off key 2 should become separated from the through hole 14 of the plug body 1.

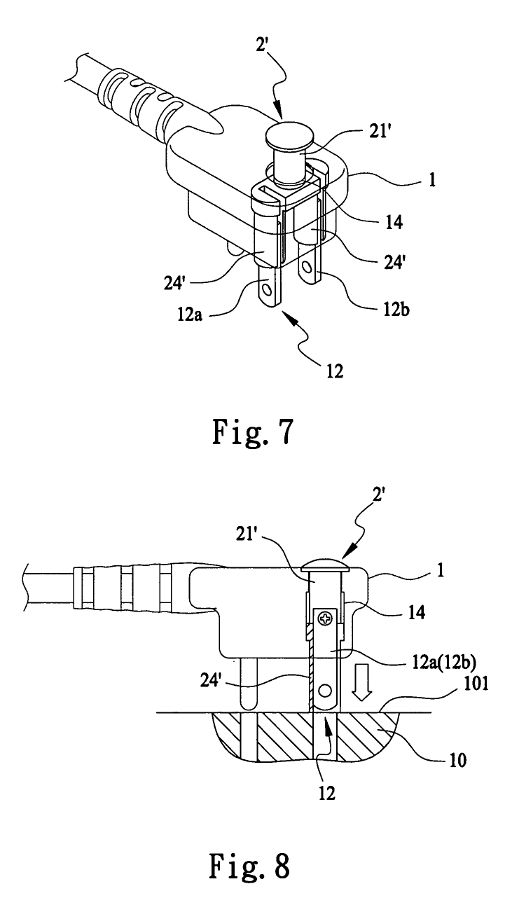

FIG. 7 is an assembled perspective view of a safety plug according to another embodiment of the present invention. In this second embodiment, the safety plug includes a push-off key 2′ having a shank portion 21′, and at least one hollow sleeve 24′ connected to a lower end of the shank portion 21′. In the illustrated drawing, there are two hollow sleeves 24′ separately corresponding to the positive and the negative blade 12a, 12b of the power connection unit 12. The push-off key 2′ is mounted on the plug body 1 with the shank portion 21′ located in the through hole 14 of the plug body 1 and the at least one hollow sleeve 24′ axially movably located around the power connection unit 12. It is noted a lower end of the at least one hollow sleeve 24′ is aligned with the contact surface 11 before the push-off key 2′ is depressed.

Please refer to FIG. 8 that shows the manner of operating the push-off key 2′ to unplug the safety plug according to the second embodiment of the present invention with only one hand. When the push-off key 2′ is depressed, the at least one hollow sleeve 24′ is caused to press the lower end against the end surface 101 of the socket 10 or the electric equipment and push the power connection unit 12 off the socket 10 or the electric equipment, allowing a user to effortlessly unplug the plug body 1 with only one hand. Meanwhile, the hollow sleeve 24′ also encloses the power connection unit 12, including the positive and negative blades 12a, 12b, exposed and projected from the contact surface 11 of the plug body 1 to effectively protect the power connection unit 12 and shield the user's hand unplugging the safety plug from dangerously contacting with the blades 12a, 12b.

What is claimed is:

1. A safety plug allowing unplugging with one hand, comprising:
a plug body being provided at one side with a contact surface, on which at least one power connection unit is provided, at any one side other than said contact surface with a power cord electrically connected with said power connection unit, and at a selected place with at least one through hole normal to and extended to said contact surface; and
a push-off key having a shank portion and an expanded head portion formed at a top of said shank portion for a user to apply a downward force thereat; and
said shank portion of said push-off key being axially movably located in said through hole of said plug body with said expanded head portion exposed and projected from said plug body, and said shank portion having a lower end aligned with said contact surface of said plug body before said push-off key is depressed.

2. The safety plug allowing unplugging with one hand as claimed in claim 1, wherein said through hole of said plug body is internally provided at a central area with a transverse bar; and wherein said shank portion of said push-off key is provided at a predetermined position with an axially extended guide slot; and said transverse bar having dimensions matching that of said guide slot to extend across said guide slot.

3. The safety plug allowing unplugging with one hand as claimed in claim 2, wherein said guide slot is provided at a lower end of at least one sidewall thereof with a first inward protrusion, and near an upper end of at least one sidewall thereof with a second inward protrusion; and said first and said second inward protrusion serving as lower and upper dead points, respectively, for said transverse bar moving in said guide slot of said push-off key.

4. The safety plug allowing unplugging with one hand as claimed in claim 1, wherein said power connection unit includes blades projected from said contact surface of said plug body.

5. The safety plug allowing unplugging with one hand as claimed in claim 1, wherein said power connection unit includes terminal insertion holes formed on said contact surface of said plug body.

6. The safety plug allowing unplugging with one hand as claimed in claim 1, wherein said push-off key includes at least one hollow sleeve connected to the lower end of said shank portion to axially movably located around said at least one power connection unit on said plug body; and a lower end of said at least one hollow sleeve being aligned with said contact surface before said push-off key is depressed into said through hole of said plug body.

7. The safety plug allowing unplugging with one hand as claimed in claim 6, wherein said push-off key has two said hollow sleeves connected to the lower end of said shank portion corresponding to said at least one power connection unit on said plug body.
